(19) United States
(12) Patent Application Publication
(10) Pub. No.: US 2002/0023039 A1
(43) Pub. Date: Feb. 21, 2002

(54) Computerized system and method for conducting an online virtual auction

(76) Inventors: Daniel Scott Fritsch, Chapel Hill, NC (US); Jason G. Tatge, Cordova, TN (US)

Correspondence Address: BAKER, DONELSON, BEARMAN & CALDWELL, Suite 900, Five Concourse Parkway, Atlanta, GA, 30328, US

(21) Appl. No.: 09/729,574

(22) Filed: Dec. 4, 2000

Related U.S. Application Data
(60) Provisional application No. 60/168,816, filed on Dec. 3, 1999.

(51) Int. Cl. G06F 17/60

(52) U.S. Cl. 705/37; 705/26

(57) ABSTRACT

An auction system and method is disclosed which displays a graphical representation of a buy bid and ask bid along a scale. A user may enter a new bid by moving the computer screen cursor to a position on the scale and initiating an entry command. The system then reconfigures the scale to reflect the newly entered bid.

### REFERENCE TO RELATED APPLICATION

This application is based on U.S. patent application Ser. No. 60/168,816 filed Dec. 3, 1999.

### FIELD OF INVENTION

The invention relates generally to virtual auctions, and more particularly to a virtual market place being accessible in real-time to many users through a computer network wherein the bids and selection of new bids are illustrated graphically.

### BACKGROUND OF THE INVENTION

Whether an auction is performed over the Internet or in a more traditional setting, they are historically one-dimensional in nature and scope. In other works, an auctioneer attempts to secure a series of progressively higher bids until a highest bid is secured and a sale made. At times a reverse auction is held, whereby the bidding process is done in reverse and eventually the lowest bidder makes the sale.

It is an object of the present invention to add a new dimension to the auction process. In a true, free-flowing marketplace it is not uncommon for an individual or company to be a buyer at one price and a seller simultaneously at a slightly higher price. For example, an agricultural trading company might be a buyer of barge corn at New Orleans at $2.15 per bushel, and at the same time be a seller at $2.19 per bushel. However to date, all Internet auction and trading platforms have been one dimensional in nature. The bid/ask marketplace according to the present invention allows these 2-dimensional transactions to occur simultaneously.

Further, current one-dimensional Internet trading platforms may be able to secure the highest price, or lowest price for a given product. However, from the time the highest price (or lowest price) is obtained until the time the buyer accepts or denies the high (or low) offer price can be several hours, or even days. It is an object of the present invention to seek out the best price and determine whether the buyer either accepts or denies the price within minutes of when the auction is closed. It is important to note that if a buyer or seller decides to utilize a proxy bid or offer (not present when the auction was held) they should automatically agree to the purchase or sale if their price is accepted.

Another problem associated with auction sites has been the opportunity for error in entering a buy or ask bid. The bidder typically enters a new bid by manually typing a new bid monetary amount and submitting the new amount electronically to the auctioneer. However, because of the pace of some auctions bidders often hurriedly submit and enter their bids without carefully examining their submission. As such, bids are often entered in an incorrect amount which may result in the bidder buying or selling the item at an unwanted price. For example, a buyer may wish to enter a buy bid amount of $24.50 but instead accidently type in and enter a buy bid of $25.40, which could result in the acceptance of the erroneous buy bid in an amount higher than the desired buy bid.

Accordingly, it is seen that a need remains for a method of auctioning that reduces the opportunity for errors in entering the bid amount. It is the provision of such that the present invention is primarily directed.

### BRIEF DESCRIPTION OF THE FIGURES

FIG. 1 illustrates an overview of a computer network utilized according to a preferred form of the invention;

FIG. 2 illustrates an auction application architecture according to a preferred form of the invention;

FIGS. 3-12 are a series of illustrations showing the monitor screen of a workstation through the different steps of an auction.

### DETAILED DESCRIPTION OF THE INVENTION

With reference next to the drawing, when the system according to the present invention is utilized, the trading platform identifies and keeps track of all participants registered for a given auction. In turn, the auction platform sends a message to each participant telling them whether they have the current bid or do not have the bid. Conventional bid/ask markets require that the user refresh their screen to get the latest bid. In contrast, the present invention preferably utilizes Java based bidding screens and automatically transmits bids to all participants as they occur in real-time.

The bidding process in a real-time marketplace can be fast and furious. Bidding does not necessarily occur in even price increments as prices can jump several increments at a time. Conventional systems which have bidders type in bids manually can often cause errors (for example, it would be easy for a person to type in $20.5 instead of the desired $2.05). The graphical interface illustrated by a color bar indicating the current buy bid and current ask bid, also known as sell or offer bid, on a scale according to the present invention allows market participants (buyers or sellers) to change the bid amount graphically through the color bar to a desired bidding level, thereby eliminating any typing and associated errors. A numerical representation (i.e. $2.05) as well as the change in the color bar indicates further price changes. Numerical price changes and the price spread between bid and ask are displayed graphically. Audio feedback, i.e. a beep, when the bid changes, can also be incorporated according to a preferred embodiment of the system according to the present invention.

The look and feel of real-time bidding with graphical interface can take on various forms. Multiple lots, each with its own bidding graphic can be displayed on one screen. In the preferred embodiment, these graphics are displayed as a line graph; a bar chart; or any other suitable graphical interface.

The present invention further incorporates instantaneous scale changes, as the bid/ask prices approach each other. In other words, the system according to the preferred embodiment preferably automatically rescales the graphics to dynamically calculate and represent the changing environment and hence bidding increments. For example, the following illustrates how this would occur:

TABLE 1

| Current Buy | | | |
|---|---|---|---|
| Bid | Current Sell Bid | Bid/Ask Spread | Bidding Increment |
| $100.00 | $150.00 | $50.00 | $5.00 |
| $125.00 | $135.00 | $10.00 | $1.00 |
| $128.00 | $130.00 | $2.00 | $0.25 |

Basically, the starting buy bid is $100.00 and the starting sell bid is $150.00, resulting in a bid/ask spread of $50.00. The system according to the present invention preferably is preprogrammed to use 10 bidding increments in this particular example resulting in an increment of $5.00 for each bid. After further bidding the spread, as indicated in the second entry in Table 1, the bid/ask spread is reduced to $10.00 resulting in a bidding increment of $1.00 being generated. Finally, the bid/ask spread has been reduced to $2.00, however in this particular example the system is provided with a minimum bid increment of $0.25 and hence that is generated and used for final bidding. A trade, and hence both the ask and bid being $129.25, being completed at $129.25 for example. It should be understood that the minimal bid increment is determined by the amount of spread between the buy bid and sell bid, but that it must also maintain standard pricing increments. Also, the minimal increment may be established by a seller or the auctioneer. A mathematical formula may be instituted to derive these minimal bid increments according to the spread.

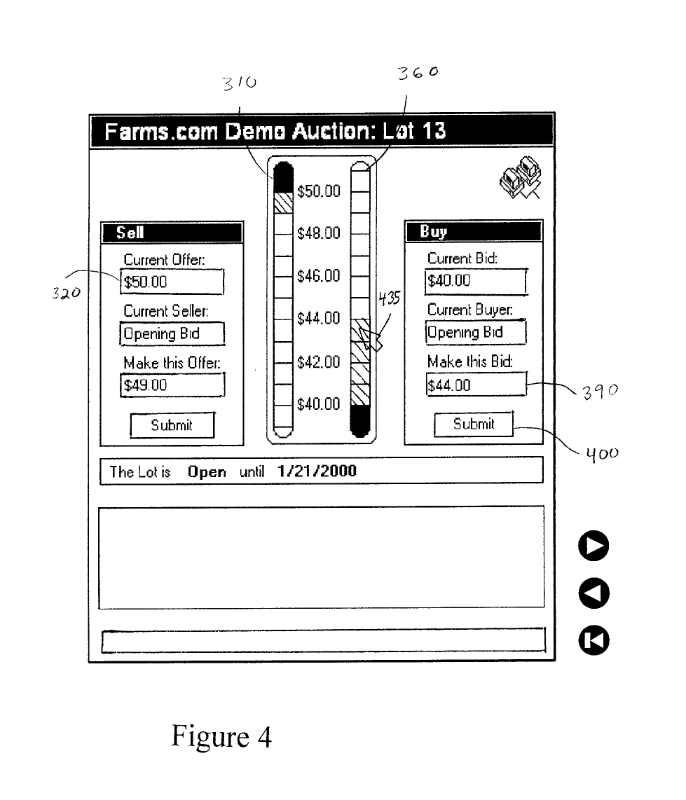

This distinct format allows for a quick and efficient trading platform, and at the same time achieves the best price. Again, it is important to note that the same graphic is scaled accordingly throughout the process, which allows for easy visualization, whether the price spread is $50.00 or $0.50. Alternatively, the scale can remain unchanged (see, FIGS. 4A-9B, for example).

Further, live markets require communications between traders and the market. The system according to the present invention has the ability to instantaneously send discrete messages to an individual participant or a global message to all (although a verbal transmission will be achievable when broadband technology becomes more widely adopted by our market participants). Participants likewise will be able to communicate back to the market in private. For example, a large 1,000,000-unit order, with 100,000-unit minimums is occurring across a platform according to the present invention. The winning bidder decides to take 400,000-units of the order, and now the remaining 600,000 units must offered. The market manager can send a discrete message to the winning bidder and in turn discover that their bid was only good for 400,000 units. The market manager can then tell participants that 600,000 units are still up for play, and continue the market. The present invention can support various auction types, including: Multi-lot Regular and Reverse Auctions; Single-lot Regular and Reverse Auctions; Multi-lot and Single-lot Bid/Ask Auctions; and Multi-lot Dutch Auctions (fully-automated).

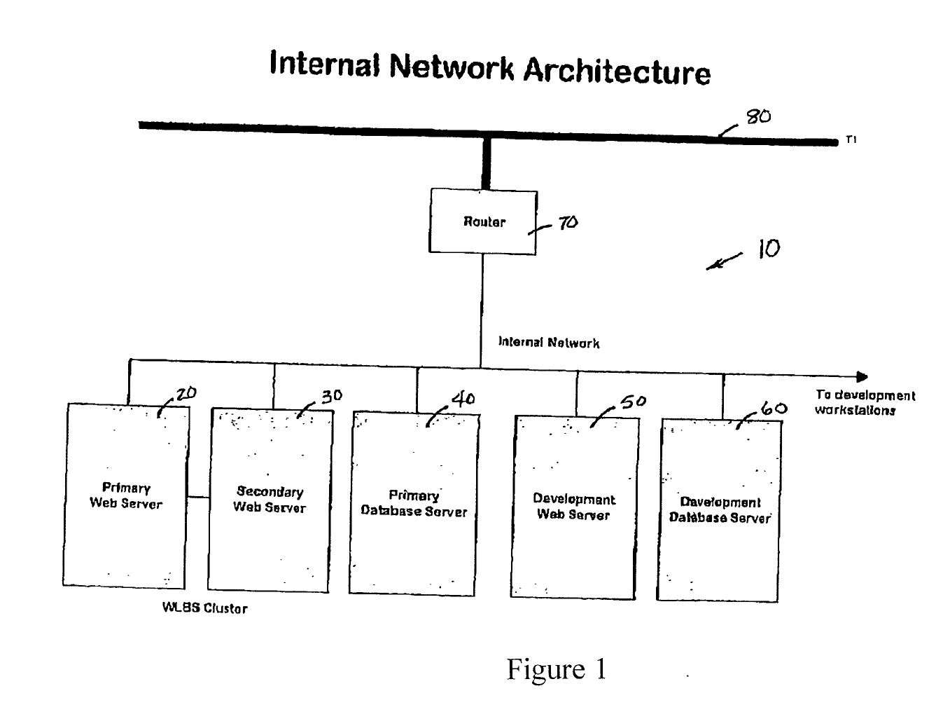

Referring now to the numerous figures, wherein like references identify like elements of the invention, FIG. 1 illustrates an overview of a computer network 10 utilized according to a preferred form of the invention. The network 10 includes a primary web server 20, a secondary web server 30 (which collectively form conventional Windows Load Balancing Services Cluster as is well known), a primary database server 40, a development web server 50, and a development database server 60 all connected through a router 70 to a computer network 80. In the preferred form the computer network 80 takes the form of the Internet with a connection being made by a T1 line for example.

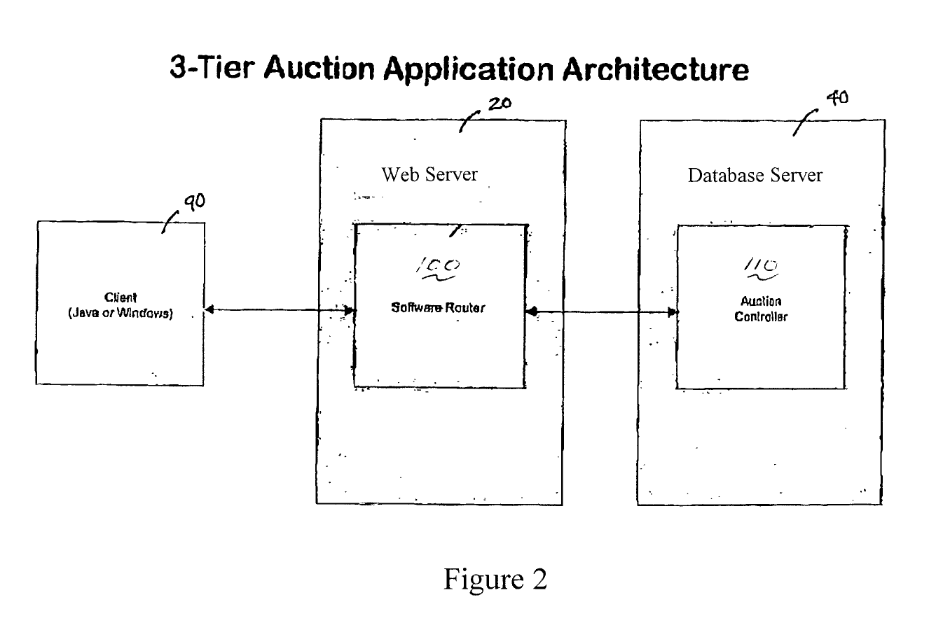

Referring now also to FIG. 2, therein is illustrated an auction application architecture used according to a preferred form of the invention. The system according to the present invention includes a client or user interface 90, routing software 100 preferably implemented on the web server 20 and auction controller software 110 preferably implemented on the database server 40. It should be understood the interface 90 and routing software 100, and the routing software 100 and auction controller 110 are communicable with one another. The web servers preferably used include dual Pentium III processors, are redundant and include Raid 5 drives which provide data striping at the byte level and also stripe error correction, as is well known. Automatic database mirroring and daily tape backups are also preferably implemented.

The Client 90 preferably runs as a Java applet in browser software locally at a user's site. There are preferably separate applets available for single (e.g., PVA) and multi-lot auctions and for auction management. The applets preferably connect directly to the Software Router 100 using TCP/IP sockets and a proprietary transfer protocol. The applets preferably continually listen for messages from the Software Router 100 and monitor connection viability. The applets are preferably compatible with industry standard browser software (i.e., Microsoft Internet Explorer and Netscape Navigator) and support dynamic HTML and client script for online auction lot listings and forms-based input (new listings). The applets are preferably implemented using “pure” Java 1.1 for bidder applications which results in Netscape 4.06 and IE 4.0 and greater browsers being supported.

The software router 100 preferably maintains client socket connections and stores a list of IP addresses of all connected users. The software router 100 further preferably handles messaging to and from clients 90 and the auction controller 110, however does not perform any of the business (auction) logic.

The software router 100 runs as a custom Microsoft Windows NT service. Windows Load Balancing Services (“WLBS”) provides for redundancy and high-availability so client (90) connections are maintained even in the event of a back-end server (database server 110) disruption.

The auction controller 110 preferably runs under Microsoft Transaction Server, handles client messages sent through the Router software 100, returns all relevant auction information to clients 90 via the router software 100, handles all database updates and notifies clients 90 of changes via the router software 100, and checks and maintains database state. The database server 110 is preferably implemented using SQL Server 7.0. The auction controller 110 preferably runs under Microsoft Transaction Server for efficiency (connection pooling) and automatic transaction support.

The system according to the preferred form of the present invention is readily scalable as it conforms to Microsoft Windows Distributed internet Applications Architecture (Windows DNA), the architecture permits multiple auctions to be run concurrently, all transmitted messages are very small (<<1K) which provides for very low bandwidth connections and thousands of simultaneous bidders, and Windows Load Balancing Services (WLBS) allows for multiple Web services and Software Router services to be run simultaneously.

According to a preferred form of the invention, a client 90 can be initialized as follows. The user connects via a web browser after a login and password are validated and an auction is selected. A Java Bidder Applet (JBA) 90 loads from Web Server 20 and establishes a direct socket connection to the Software Router (SR) 100. The JBA 90 sends a request to the SR 100 for auction info and supplies buyerid (buyer identification) and auctionid (auction identification) (i.e. data to identify th operator of JBA 90 and the auction the operator of JBA 90 wishes to join). The SR 100 retrieves auction and active lot information from Auction Controller (AC) 110 and sends it back to JBA 90.

Once initiated, bids can be placed in accordance with the following preferred method. The JBA 90 sends a message to the SR 100 to place a bid and supplies auctionid, lot number, bid amount, and buyerid (same information as before plus the amount and price). The SR 100 sends the bid request to the AC 100 which checks to see if the bid is acceptable. If so, the AC 110 posts the new bid in the database and sends a message back to SR 100. The SR 100 in turn sends the message back to bidder JBA 90 indicating the bid was accepted and broadcasts the new bid amount to all connected JBA clients 90. If not, the AC 110 sends an error message back to SR 100, which routes an error message back to bidder JBA 90.

Preferably, there is a corresponding JAVA Auction Applet (“JAA”) which enables authorized users to manage auction for example by: starting or stopping an auction; sending personalized or global messages to bidders; editing lot information including: lot status, asking bid, etc.; and disabling bidders. A JAA preferably communicates through the software router 100 with the AC 110 in the same manner as a JBA. Preferably, all actions performed through a JAA and impact an auction causes the SR 100 to send updated auction data to all bidders (JBA's).

Both auction management (JAA) and bidding (JBA) use the same messaging protocol, although many more messages are available to the auction management applications. The protocol utilized preferably is designed to minimize an amount of information transmitted across the Internet, so that many simultaneous users can participate in auctions without saturating the connection to the SR 100. Moreover, the messaging protocol is preferably extensible so that new functions can be made available to bidders and auction managers as the need arises.

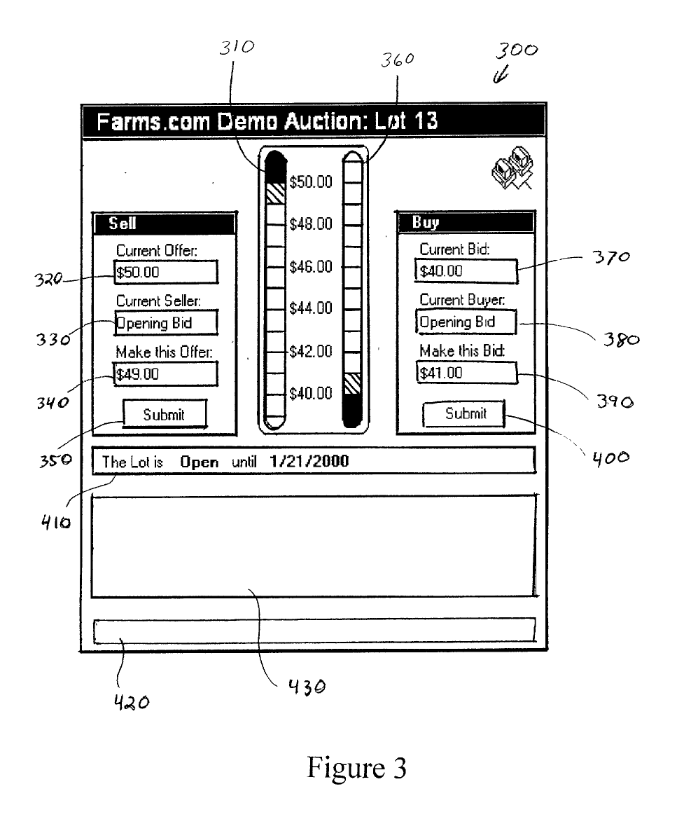

Referring now to FIG. 3, therein is illustrated a user interface 300 according to a preferred form of the present invention. The interface 300 includes a sell bid selector (graphical scale element) 310, sell current offer amount window 320, a current seller identifier window 330, a new sell offer amount identifier window 340, and a new offer bid submit button 350. Similarly, the interface 300 further includes a buy bid selector (graphical scale element) 360, buy current bid amount window 370, a current buyer identifier window 380, new buy bid amount identifier window 390, and a new buy bid submit button 400. The interface 300 further includes a lot status indicator window 410, a chat window 420 and a chat history window 430. The computer monitor also displays a conventional, movable screen cursor 435 the position of which is manually controlled by the user through movement of the computer mouse, entry by key pad or other similar device, and the operation of which is controlled by the computer operating system.

With continued reference to FIG. 3, there is illustrated an example of an automatic auction wherein the starting sell offer (bid) is $50.00 as shown in current offer amount window 320, and the starting buy bid is $40.00 as shown in the buy current bid amount window 370. The system automatically set the new sell offer amount identifier window 340 at the next decreasing incremental level of $49.00 and the new buy bid identifier window 390 at the next increasing incremental level of $41.00. Graphically, the sell bid selector 310 also incrementally illustrates the prospective new sell offer amount of $49.00. It should be noted that the difference between the current offer of $50.00 and the new sell offer amount of $49.00 is colored or shaded, herein cross-hatched, differently from that of the current bid so that users can readily identify the difference. Similarly, the difference between the current bid amount of $40.00 and the new buy bid amount of $41.00 is graphically indicated by difference in color, shading or as herein cross-hatching.

As shown in FIG. 4, a user, in this example a buyer, may disregard the automatic incremental increase in the next sell offer or buy bid shown by the cross hatched section in order to increase the user's bid in an amount greater than the one incremental level. To do so, the user moves the screen cursor 435 to the incremental level upon the buy bid selector 360 which represents the user's desired buy bid. Herein, the buyer has bypassed the automatic buy bid of $41.00 and has instead moved the cursor to the $44.00 increment level upon the buy bid selector 360. The user then initiates an entry signal by conventionally clicking upon the computer mouse left click key. Entry results monetary values in the graphical incremental level are shown in the new buy bid amount identifier window 390. Thus, the user is able to confirm the desired entry both graphically upon the buy bid selector 360 and numerically within the new bid amount identifier window 390. It should be noted that this is accomplished through conventional positioning recognition software by recording the relative x-y position of each element of the bid selector 310 or 360 and correlating it to the relative x-y position of the cursor 435. For example, a cursor position of 450/250 is correlated to the underlying scale wherein an x-y position of 450/250 indicates a bid amount of $44.00. The user then finalizes entry of the bid amount by moving the cursor 435 to and clicking upon the new buy bid submit button 400.

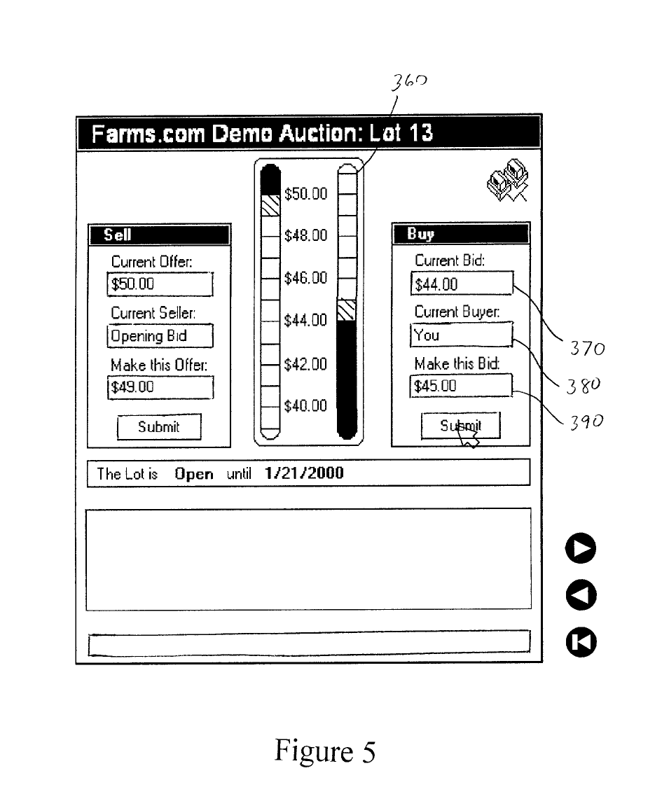

As shown in FIG. 5, once the buy bid is accepted by the auctioneer the buy bid selector 360 and buy current bid amount window 370 are reconfigured to indicate the new buy bid amount of $44.00. The current buyer identifier window 380 is also updated to indicate that the user's bid has been accepted and therefore that user is the current buyer with the indication of the current buyer being “YOU”. The buy bid selector 360 and new buy bid amount identifier 390 are updated to indicate a new automatic incremental increase of one incremental level, i.e. the new buy bid level is increased to $45.00.

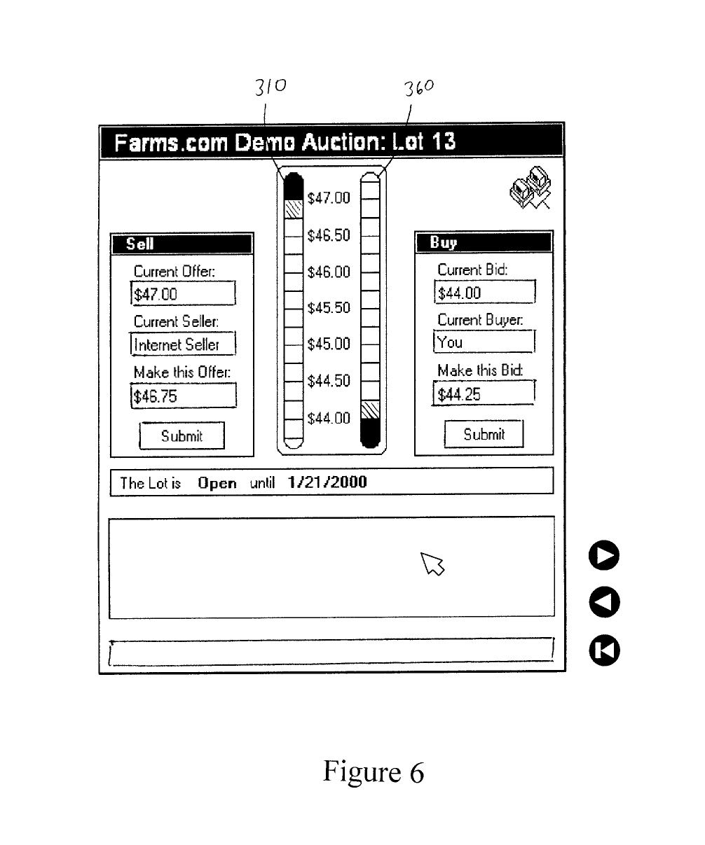

With reference next to FIG. 6, should the seller user decrease the current sell bid amount from $50.00 to $47.00, either through a series of automatic transactions or by manually increasing the sell bid by more that one incremental level as previously describe through the use of the cursor 435, the spread between the sell current offer amount of $47.00 and the buy current bid amount of $44.00 is less that the preferred ten incremental levels. As such, the sell bid selector 310 and the buy bid selector 360 are graphically reconfigured so that the monetary amount of each incremental level is reduced, as previously discussed the incremental levels may be determined by simply mathematical formulas. Here, the incremental level is reduced from $1.00 to 50 cents. It should be noted that the incremental level must be equal to or greater than a minimum value set by either market parameters or the seller of the goods. The system automatically changes the incremental level so that bidders can refine their bids as the spread decreases. This automatic reconfiguration of the graphics allows users to immediately recognize the narrowing of the spread and to recognize that the bid increments need not be as large. This aids in preventing bidders from unknowingly increasing the next bid beyond a recognized minimal increase.

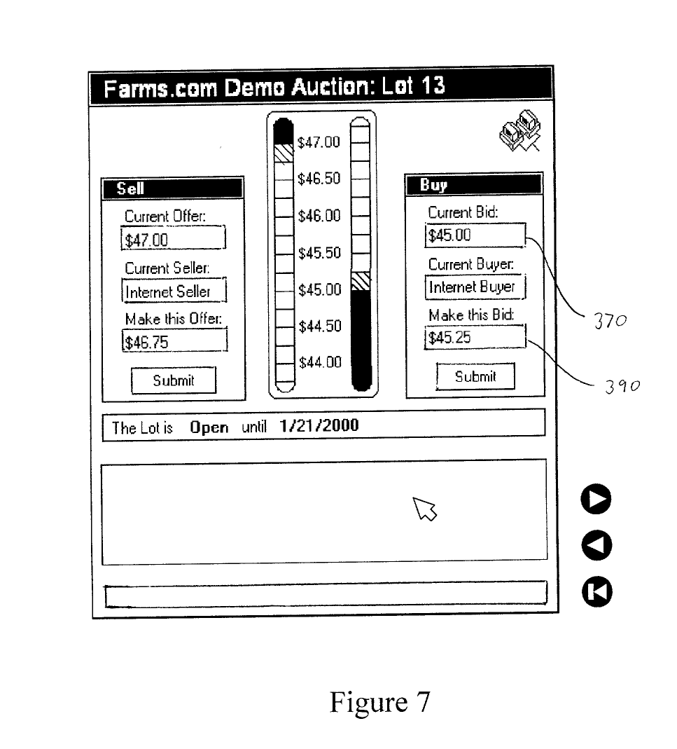

With reference next to FIG. 7, there is shown the entry of another buyer who has increased the buy bid from $44.00 to $45.00. This results in a change in the buy current bid amount window 370 to $45.00, a change in the current buyer identifier 380 to “INTERNET BUYER”, a change in the new buy bid amount identifier 390 to $44.25, and a graphical reconfiguration of the buy bid selector 360 to reflect both the new current bid amount and the new incrementally increased next bid amount of $45.25.

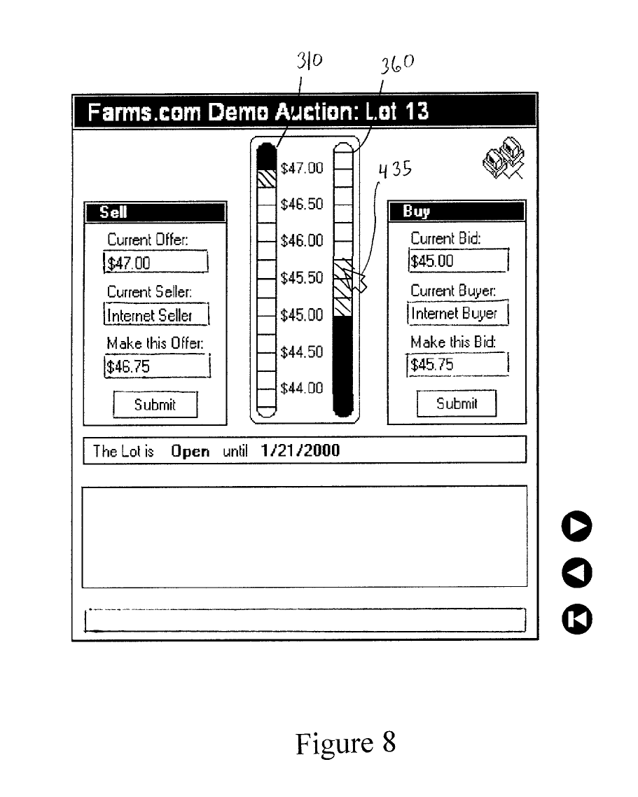

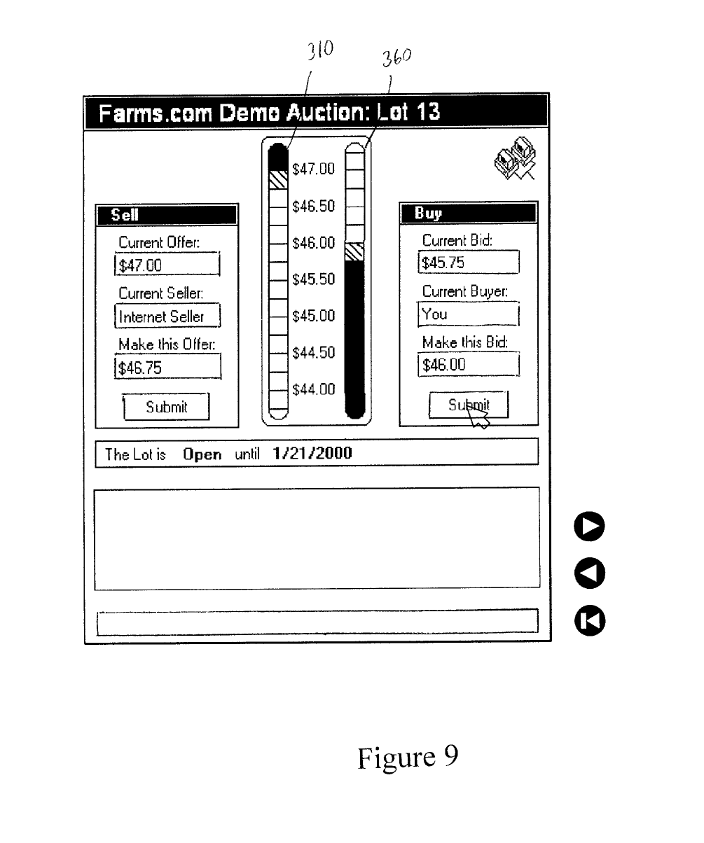

With reference next to FIG. 8, there is shown a buyer moving the cursor 435 to an incremental bid level of $45.75. The entry and acceptance of this bid resulting in the that illustrated in FIG. 9. Now, the current bid amount is $45.75 and the new incrementally increased next bid amount is automatically set at the next incremental increase level of $46.00.

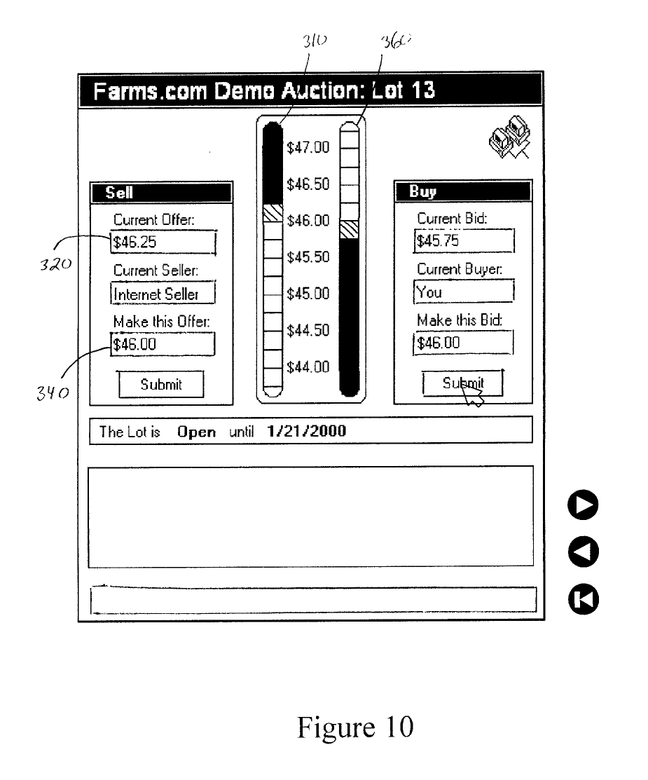

With reference next to FIG. 10, the seller has decreased the sell current offer from $47.00 to $46.25. Again, the seller may accomplish such a change through either the automatic incremental increases or through the manual method utilizing the cursor to enter the desire incremental level. The sell current offer amount window 320, new sell offer amount identifier window 340, and graphically the sell bid selector 310 are all reconfigured to update the change in the current offer amount.

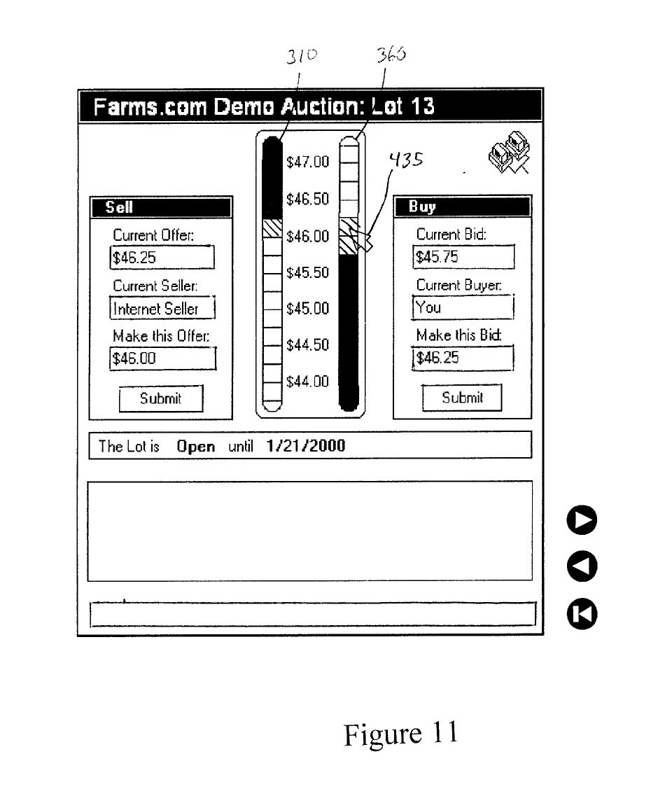

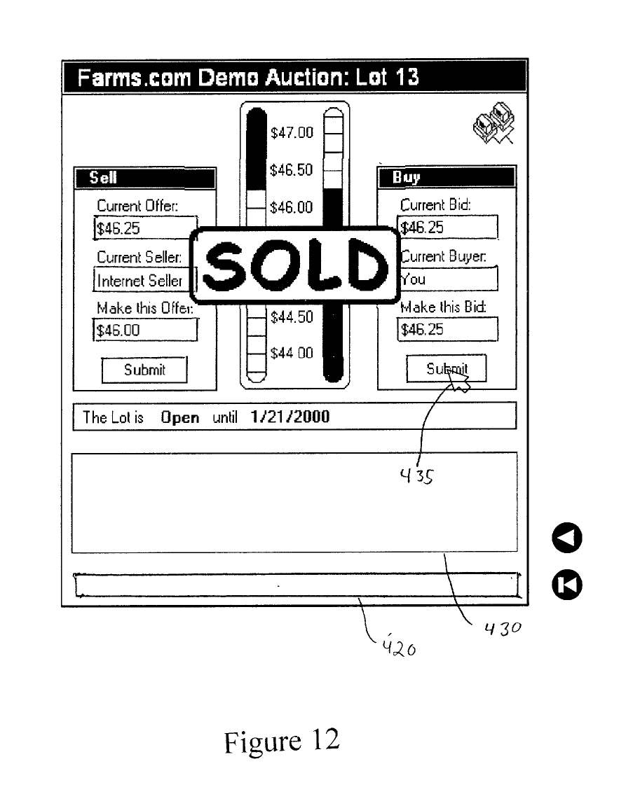

With reference next to FIG. 11, there is shown a buyer moving the cursor 435 to an incremental bid level of $46.25. The entry and acceptance of this bid results in the buy current bid amount of $46.25 equalling the sell current offer amount of $46.25, as shown in FIG. 12. This equalling of the buy and sell bids results in the purchase of the good being auctioned. It should be understood that messages could have been sent between the first and second users or between users and the auctioneer using the chat window 420, with all past messages being displayed in the chat history 430.

It should be understood that the present invention may include a graphic display having only one selector (graphical element) wherein the sell bid may be shown on the one portion of the selector and the buy bid shown on another portion of the selector with the bid incremental levels shown therebetween. The user may then graphically change the bid amount by conventionally clicking and dragging the graphic image with the use of the cursor 435.

It should be understood that the present invention may be used in connection with a global computer network system interconnecting multiple remote users each having a computer or workstation or with a central computer system having multiple video workstation monitors.

It thus is seen that a new method of auctioning and system for conducting auctions is now provided that has distinct advantages over the prior art. While the invention has been described in detail with particular reference to the preferred embodiments thereof, it should be understood that many modifications, additions and deletions, may be made thereto without departure from the spirit and scope of the invention as set forth in the following claims.

1. A method of conducting an auction utilizing a network computer system connectable to a plurality of monitors comprising the steps of:
(A) displaying an image of at least one scaled graph having incremental levels upon a computer monitor reflecting a range of monetary values;
(B) graphically displaying an ask bid at a select incremental level upon the scaled graph;
(C) graphically displaying a buy bid at a select incremental level upon the scaled graph;
(D) displaying a movable cursor which is controllably positionable upon the monitor by an operator; and
(E) initializing a new ask bid or buy bid by moving the cursor to a new incremental level upon the scalable graph and providing a select signal.

2. The method of claim 1 further comprising the step of (F) numerically displaying the monetary value of the newly selected incremental level upon the monitor.

3. The method of claim 1 further comprising the step of (F) authorizing acceptance of the newly selected incremental level.

4. The method of claim 1 further comprising the step of reconfiguring the display image of the scaled graph to illustrate the newly selected incremental level of the new ask bid or new buy bid.

5. The method of claim 1 wherein the ask bid is displayed on one scaled graph and the buy bid is displayed on a second scaled graph.

6. The method of claim 1 wherein the ask bid and buy bid are displayed on one scaled graph.

7. A method of conducting an auction utilizing a networked computer system having a plurality of coupled monitors, the method comprising the steps of:
(A) displaying a graphical scale upon a monitor;
(B) displaying a buy bid upon the graphical scale;
(C) displaying an ask bid upon the graphical scale;
(D) displaying a plurality of incremental bid levels upon the graphical scale between the buy bid and the ask bid, and
(E) graphically selecting one of the incremental bid levels between the buy bid and the ask bid to initiate a new buy bid or ask bid.

8. The method of claim 7 further comprising the step of (F) numerically displaying the monetary value of the newly selected incremental bid level upon the monitor.

9. The method of claim 7 further comprising the step of (F) authorizing acceptance of the newly selected incremental bid level.

10. The method of claim 7 further comprising the step of reconfiguring the display image of the scale to illustrate the newly selected incremental bid level of the new ask bid or new buy bid.

11. A system for auctioning goods between remote users and an auction service provider comprising:
(A) a host computer network, including database server means to electronically store auction data and means to access and transmit auction data in response to user commands;
(B) remote computer workstations including a video monitor, means to send user commands to the host computer network, and means to receive and display on the video monitor the auction data from the host computer network;
(C) communication network means for electronically linking the computer workstations to the host computer network;
(D) means for generating a graph or graphs upon the video monitors;
(E) means for displaying a sell bid upon a graph;
(F) means for displaying a buy bid upon a graph;
(G) means for displaying a movable graphic indicator upon the monitor;
(H) means for initiating an entry signal; and
(I) means for redisplaying the sell bid or buy bid on the monitor in response to the graphic indicator being displayed upon the graph between the sell bid and the buy bid and the initiation of the entry signal for the entry signal means.

12. A system for auctioning goods comprising,
(A) a networked computer system having a plurality of monitors;
(B) means for generating a graph having a plurality of incremental levels representing monetary values;
(C) means for generating a movable indicator upon a video monitor;
(D) means for initiating an entry signal;
(E) means for correlating the relative position of the indicator positioned upon the graph with an incremental level of monetary value;
(F) means for entering a monetary bid amount correlating to the incremental level of a monetary value correlating to the position of the cursor in response to the initiation of an entry signal.

13. The system of claim 12 wherein said means for generating a graph also generates a numeric representation of the entered monetary bid amount.

14. A computerized system for conducting a real-time online virtual auction over a computer network, said system comprising:
a plurality of user interfaces each including:
a first graphical display element manifesting a plurality of user selectable sell offer amounts dependent upon a current sell offer amount and a current buy offer amount,
a second graphical display element manifesting a plurality of user selectable buy offer amounts dependent upon said current sell offer amount and said current buy offer amount, and,
means for submitting any selected one of said sell offer amounts and buy offer amounts, wherein said first and second graphical elements of each of said plurality of interfaces are all automatically selectively responsive to said means for submitting of any of said plurality of interfaces;
a router electronically coupled over said computer network to each of said plurality of user interfaces; and,
a database server electronically coupled to said router and for storing data relating to at least one auction, said database server and plurality of user interfaces being automatically mutually responsive to one another through said router dependent upon a predetermined set of rules associated with said at least one auction.
